(19) United States
(12) Patent Application Publication
(10) Pub. No.: US 2013/0276577 A1
(43) Pub. Date: Oct. 24, 2013

(54) HYBRID DRIVE FOR A TRUCK MIXING DRUM

(71) Applicants: Bert Kroschel, Klein Ronnau (DE); Joachim Hergt, Bargteheide (DE); Jan Jakubovic, Zilina (SK); Peter Krissak, Zilina (SK)

(72) Inventors: Bert Kroschel, Klein Ronnau (DE); Joachim Hergt, Bargteheide (DE); Jan Jakubovic, Zilina (SK); Peter Krissak, Zilina (SK)

(73) Assignee: SAUER-DANFOSS GmbH & Co. OHG, Neumunster (DE)

(21) Appl. No.: 13/876,940

(22) PCT Filed: Oct. 4, 2011
(86) PCT No.: PCT/EP2011/067322

§ 371 Date: Jul. 12, 2013

(30) Foreign Application Priority Data
Oct. 1, 2010 (DE) 10 2010 047 314.6

(51) Int. Cl. B28C 5/18

(52) U.S. Cl. CPC B28C 5/1856
USPC 74/665 B

(57) ABSTRACT

The invention relates to a drive unit for a mixing drum that is disposed on a motor vehicle, in which an electric motor or a hydraulic drive comprising a displacement pump and a hydraulic motor can be used to drive the mixing drum. The low-power electric motor is used to drive the mixing drum at low rotational speed during the transport journey of the mixed concrete to the building site, while the hydraulic drive drives the mixing drum at high rotational speed during loading, mixing and discharging.

The invention relates to a drive unit for a mixing drum that is disposed on a motor vehicle, according to the preamble of claim 1.

Motor vehicles having equipment for mixing and transporting concrete to building sites have been known for a long time. They have a rotatable mixing drum disposed on a motor vehicle chassis and having a large volume, the rotation of which is usually effected by a hydraulic motor via a gearbox. The hydraulic motor is fed by a hydraulic displacement pump, which in turn is coupled to the drive engine of the motor vehicle and is driven by said pump. During the transport of the concrete to the building site, the mixing drum is generally rotated only at about 0.5 to 5 revolutions per minute, while during mixing and discharging it is operated at substantially higher rotational speeds, up to 15 rev/min. Concrete mixing and transporting vehicles of this type are known, for example from DE 10 2008 017 350 A1 or DE 35 39 550 A1.

In such concrete mixing and transporting vehicles, also called a mixer vehicle or truck mixer for short, the problem results that, when the drive engine of the motor vehicle is at a standstill, a diesel engine in most cases, the rotation of the mixing drum necessarily also comes to a standstill. This is disadvantageous when the drum is filled, since this can lead to demixing or to premature setting of the concrete, and is therefore undesired. Therefore, when the mixing drum is filled, in particular during the transport of the concrete to the building site, the mixing drum should rotate continuously. This results in the problem that, when the truck mixer is at a standstill, for example in traffic jams or during relatively long waiting times until discharge, the running drive engine of the truck mixer, in most cases a diesel engine, involuntarily causes exhaust gas and noise emissions, which are damaging to health, environmentally damaging and disruptive, in particular in enclosed spaces.

This problem and solutions thereto are known from the relevant prior art. For example, in DE 10 2008 017 350 A1, a dedicated drive independent of the drive engine of the motor vehicle, a diesel engine, is provided for the hydraulic pump, which drive is likewise constructed as an internal combustion engine.

U.S. Pat. No. 3,053,044 shows an additional second hydraulic high output drive for the rotary drive of a secondary unit. The high output pump of the hydraulic additional drive can be driven either via the truck mixer gearbox from the drive engine of the truck mixer or via an auxiliary drive, which can be an electric motor. Irrespective of the type of drive of the high output pump, the mixing drum is set rotating via a hydraulic motor supplied with pressurized fluid by the high output pump.

In U.S. Pat. No. 4,542,990, a hydrostatic drive for driving a mixing drum is shown, wherein the hydrostatic drive, similarly to U.S. Pat. No. 3,053,044, can be driven on the pump side by an electric motor. The rotary drive of the mixing drum is also always hydraulic in U.S. Pat. No. 4,542,990.

In order to solve the same problem, JP 2003-301802 A describes a drive unit for a mixing drum that is disposed on a motor vehicle in which, in addition to the direct drive of the hydraulic motor via a hydraulic pump coupled to the drive engine of the motor vehicle, a further hydraulic pump is provided. This further hydraulic pump can likewise be connected to the hydraulic motor of the mixing drum via hydraulic lines and valves. The further hydraulic pump is, however, driven by an electric motor, which can be fed from the electrical system of the motor vehicle, that is to say from the usual power supply of the latter. When the drive engine of the mixer vehicle is at a standstill, the electric motor comes into action as required and maintains the rotation of the drum via the hydraulic drive.

The disadvantage with these solutions is that the separate drive motor for the displacement pump has to be designed to be so powerful that it is capable of driving the mixing drum even at the highest required rotational speed. This applies both to a drive by an internal combustion engine and to an electric motor. Such a drive, in which an appropriately dimensioned electric motor is used to drive a mixing drum directly, i.e. without the interposition of a hydraulic drive, is described in DE 20 2009 001416 U1.

A problem that occurs specifically in driving the displacement pump of a hydraulic drive of the mixing drum by the drive engine of the mixer vehicle also resides in the fact that the displacement pump connected to a power take-off of the drive engine is subjected to all the changes in rotational speed of the drive engine. As a result of the automated gearbox and the abrupt accelerations and retardations of the latter, uniform loading of the hydraulic drive cannot be guaranteed. In addition, the power take-offs of the drive engine are loaded non-uniformly, which can disrupt the gear changing operations. In addition, when the hydraulic drive is operated in the partial load range at about 5 kW, the efficiency is very low.

It is an object of the invention to provide a drive unit for a mixing drum that is disposed on a motor vehicle which, as compared with the prior art, exhibits a further improvement to the efficiency of the drive system of the mixing drum and of the truck mixer, the intention being to avoid unnecessary exhaust gas and noise emissions. The drive engine, in particular the internal combustion engine of the truck mixer, should be capable of being shut down while the rotation of the mixing drum is maintained. The drive system should further be capable of implementation inexpensively with little effort and robust and reliable in its execution.

This object is achieved by the features of the characterizing part of claim 1, as a result of the fact that a first clutch is disposed between the drive engine of the motor vehicle and the displacement pump, that a second clutch is disposed between the hydraulic motor and the truck mixer gearbox, and that the electric motor (6) is or can be connected to the truck mixer gearbox (7) in such a way that the mixing drum (8) can be driven solely by the electric motor (6).

According to the invention, in addition to driving the mixing drum via a hydraulic drive train with displacement pump and hydraulic motor, an electric motor is provided. This electric motor, with a relatively low output as compared with the hydraulic drive, is permanently connected to the truck mixer gearbox according to one achievement of the object. This means that it is permanently coupled to the drive shaft of the truck mixer gearbox, for example by a pair of gear wheels that are permanently engaged.

According to a further embodiment of the invention, the electric motor can optionally be connected to the truck mixer gearbox, which, according to claim 2, can be achieved by a third clutch, which is disposed between the output shaft of the electric motor and the drive shaft of the truck mixer gearbox.

In both design variants, provision is made for the electric motor to be used as an alternative drive of the mixing drum only when the hydraulic drive train is taken out of operation by disengaging a first and/or a second clutch. The first clutch is located between the drive engine of the mixer vehicle and the drive shaft of the hydraulic displacement pump. When this clutch is disengaged, this pump thus no longer experiences any drive. The second clutch is disposed between the output shaft of the hydraulic motor and the drive shaft of the truck mixer gearbox. It is primarily used to prevent drive power being transmitted to the hydraulic motor when the mixing drum is driven by the electric motor. This would lead to the operation of the latter as a pump, which is already undesired because of the additional loading of the electric motor effected hereby.

The electric motor according to the invention is preferably designed such that its output power is sufficient to drive the mixing drum in the lower rotational speed range suitable for the transport of the finally mixed concrete. This rotational speed range lies between 0.5 and 5 rev/min, which requires a drive output of about 5 kW. This lies substantially below the output of about 100 kW which is needed to rotate the mixing drum at up to 15 rev/min during loading, mixing and discharging.

According to the invention, the electric motor is used, for example, when finally mixed concrete is transported to the building site. The high-power driving of the mixing drum at high rotational speed during loading and mixing of the concrete has then already been completed, and the hydraulic drive train for rotating the mixing drum is taken out of operation by disengaging the first and/or second clutch/es as stipulated by the control unit. The power supply of the electric motor is activated by the control unit. The electric motor drives the mixing drum via the truck mixer gearbox, if necessary following engagement of the third clutch.

After the building site has been reached, the electric motor can remain in operation until the discharging operation is required. It is thus possible to bridge over waiting times, in which the drive engine of the mixer vehicle can also be brought to a standstill. This avoids unnecessary consumption of fossil fuels and therefore reduces the exhaust gas environmental pollution. Only when discharging is to be carried out is the driving of the mixing drum at high rotational speed required again, for which purpose the drive engine has to be started up and the hydraulic drive has to be activated by engaging the first and/or the second clutch.

In the electronic operating mode, the drive of the mixing drum is completely isolated from the behavior of the drive engine and from the fluctuations in rotational speed of the latter during the transport. Jumps in the rotational speed of the drive engine are not passed on to the mixing drum. No uncontrolled accelerations or retardations in the hydraulic drive train for the mixing drum occur, since the latter is uncoupled from the drive engine. Load-dependent fluctuations and wear as a result of pressure peaks in the hydraulic system are avoided. The synchronous running of the mixer drive and the overall efficiency of the system are better than in the case of a purely hydraulic drive of the mixing drum in accordance with the prior art. In addition, the hydraulic drive is loaded less, since it is not used during the travel to the building site and, as a result, is spared from sudden accelerations and pressure peaks.

The electric motor according to the invention is preferably fed from the electrical system of the mixer vehicle via a frequency inverter, which is part of the electric control device of the drive unit, and the rotational speed of said electric motor is regulated. The regulation advantageously comprises a rotational speed sensor, which is preferably disposed on the truck mixer gearbox. The preferred feeding of the electric motor from the electrical system means that the power required for the operation of the electric motor is taken from the on-board battery of the mixer vehicle. This rechargeable battery, i.e. an accumulator, is fed, for example, from the alternator of the drive engine of the mixer vehicle. Of course, a dedicated accumulator, which is independent of the starter battery of the drive engine of the mixer vehicle, could be provided for the power supply of the electric motor. This drive engine is usually an internal combustion engine, preferably a diesel engine.

The electric motor for driving the mixing drum can be connected to the mixing drum gearbox in such a way that, during the hydraulic driving of the mixing drum, that is to say at increased rotational speed, in particular during loading, mixing and discharging, is also driven by the hydraulic drive and thus functions as a generator in order to supply electrical energy into the energy store.

In a further embodiment, the electric motor can also be incorporated into the drive train in such a way that the electric motor assists the hydraulic motor during hydraulic driving of the mixing drum, which means that the rotational speed of the drive engine of the truck mixer and thus, in the case of an internal combustion engine, resources can be reduced and the environment is protected.

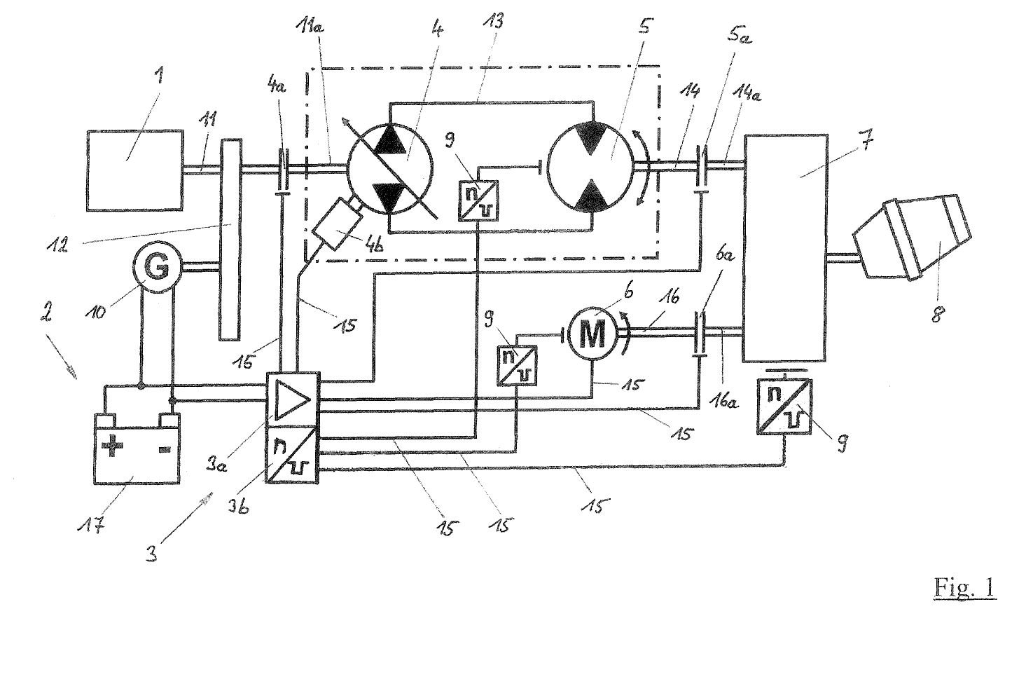

Exemplary embodiments of the invention will be described below by using FIGS. 1 to 3.

FIG. 1 shows, by way of example, the main components of a first embodiment of a drive unit according to the invention in a schematic illustration.

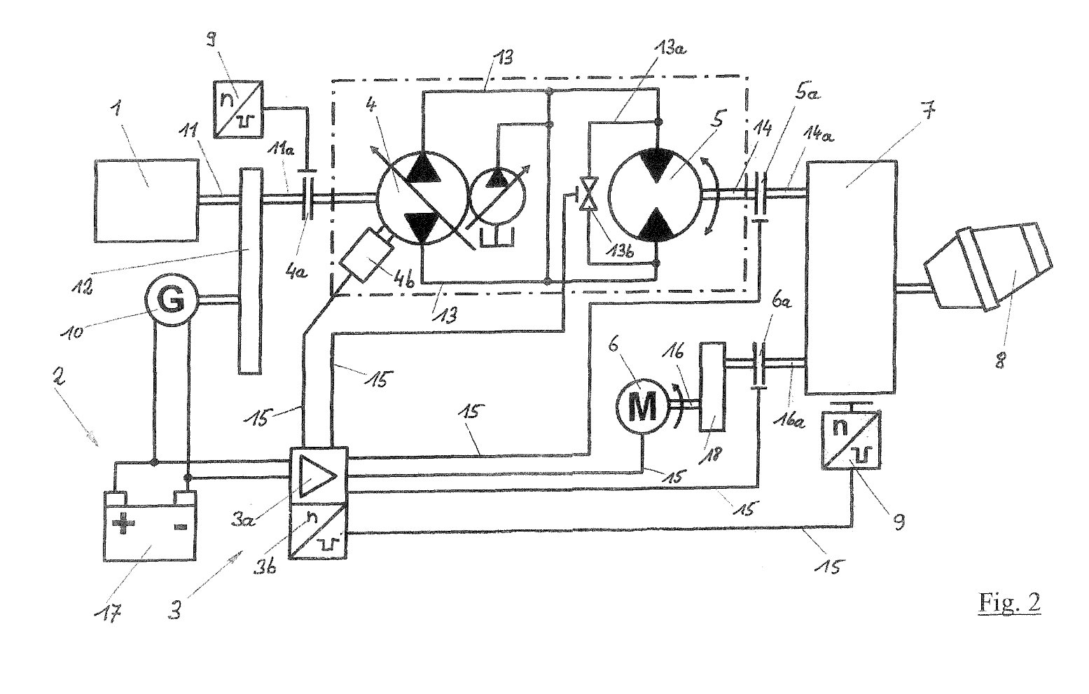

FIG. 2 shows, by way of example, the main components of a second embodiment of a drive unit according to the invention in a schematic illustration.

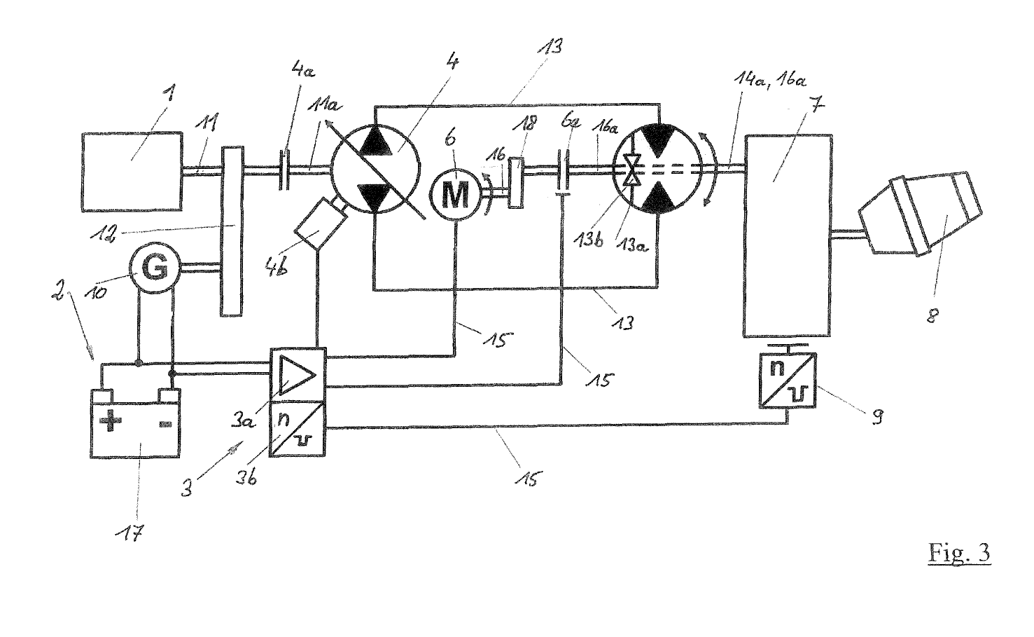

FIG. 3 shows, by way of example, the main components of a third embodiment of a drive unit according to the invention in a schematic illustration.

Illustrated in FIG. 1 is a drive engine 1 which forms the main drive of the concrete mixing and transporting vehicle, not shown. This motor vehicle will be called a truck mixer or mixer vehicle for short below. The drive engine 1 normally used is an internal combustion engine in the form of a diesel engine. Of course, the drive engine 1 used for the driving operation of the motor vehicle can also be a hydraulic motor or hybrid drive which, however, is normally driven by an internal combustion engine as main unit. The output shaft 11 of the drive engine 1 is coupled via a transmission 12 to an electric generator 10, which feeds an accumulator 17 as power supply 2 of the electrical system of the truck mixer and keeps it in the charged state. The output shaft 11 can be connected via a preferably electrically, electromechanically or mechanically driveable and actuable clutch 4a to the drive shaft 11a of a hydraulic displacement pump 4. The delivery output of the displacement pump 4 can be adjusted in a known way via an adjusting unit 4b. The displacement pump 4 is connected to the hydraulic motor 5 by hydraulic lines 13 for the pressurized fluid. The rotational speed and direction of rotation of said hydraulic motor 5 can be predefined in accordance with the control signals present on the adjusting unit 4b of the displacement pump 4. The fixed displacement motor illustrated in FIG. 1 can also be implemented in another embodiment as a displacement motor with conventional adjusting mechanism, which is self-evident to those skilled in the art.

The output shaft 14 of the hydraulic motor 5 can be coupled to the drive shaft 14a of the truck mixer gearbox 7 in a force-fitting and/or form-fitting manner by means of the preferably electrically, electromechanically or mechanically driveable and actuable further clutch 5a. The output side of the truck mixer gearbox 7 is connected to the mixing drum 8 and sets the latter rotating when a sufficient torque is present on its drive shaft 14a.

The truck mixer gearbox 7 is conventionally constructed as a step-down gearbox, for which reason, because of the ruggedness and the achievable high step-down ratio, epicyclic gearboxes of various design have become widespread. The drive and output shafts are normally resiliently mounted and permit the drive shaft 14a to be pivoted in a limited angular range relative to the mixing drum 8.

According to the invention, a drive torque acting on the truck mixer gearbox 7 can alternatively be effected by an electric motor 6, which is controlled via a control unit 3, which has control electronics 3a and a power stage 3b. According to the exemplary embodiment of FIG. 1, for this purpose the electric motor 6 can be connected via a third clutch 6a to the input side of the truck mixer gearbox 7; the clutch 6a is preferably also designed such that it can be driven and actuated electrically or electromechanically. The control signals for this purpose, and also all the other control signals for the exemplary embodiment shown in FIG. 1, are generated by the control unit 3 and transmitted to the individual subassemblies to be controlled via lines 15 illustrated only by way of example and schematically. It goes without saying that the control unit 3 is driven automatically as far as possible, for which purpose sensors or other input means, not shown, are also present. Manual interventions by the driver of the motor vehicle or by other operators are also possible, however, for which purpose switching and operating devices are provided in the driver's cab and advantageously also on an outer side of the mixer vehicle. Thus, an operator can choose the operating mode “drive the mixing drum via hydraulic motor” or “drive the mixing drum via electric motor” as desired and predefine the respectively desired rotational speed. It goes without saying that data supplied from the drive engine via a bus or similar equipment can also flow into the control of the drive unit.

Instead of the clutch 6a shown in FIG. 1 between the electric motor 6 and the truck mixer gearbox 7, according to another exemplary embodiment of the invention, a direct connection of the electric motor 6 to the truck mixer gearbox 7 can also be provided, for example by using the drive shaft 14a. The coupling of the output shaft 16 of the electric motor 6 to the drive of the mixing drum is in this case preferably carried out via a pair of gear wheels, which are in continuous engagement with each other and of which one is disposed on the output shaft 16 of the electric motor and another, for example, on the drive shaft 14a of the truck mixer gearbox 7. The output shaft 16 can, however, also act with other subassemblies of the truck mixer gearbox, for example the planet carrier or on the ring gear, in order to ensure the desired rotation of the mixing drum or to act as generator.

When the mixing drum 8 is driven by the hydraulic motor 5 with the clutches 4a and 5a engaged, the electric motor 6 in this embodiment is operated as a generator. The electric power generated here can advantageously be fed into the electrical system of the motor vehicle and, for example, in this way assist the charging of the accumulator of the power supply 2. Of course, the electric motor 6 in this design of the drive unit can also co-rotate freely without outputting energy.

The constructional variant described can also be modified to the effect that one of the aforementioned gear wheels is provided with a freewheel, so that the rotation of the drive shaft 14a of the truck mixer gearbox 7 is not transmitted to the electric motor 6. A freewheel is advantageous when the drive of the mixing drum 8 is designed such that rotation only in one direction is provided.

The clutch 6a shown in FIG. 1 between the electric motor 6 and the truck mixer gearbox 7 can be implemented, for example, by the output shaft 15 of the electric motor 6 and the drive shaft 14a of the truck mixer gearbox 7 each having a gear wheel which, for example by means of axial or radial displacement, can be moved toward each other or away from each other and therefore brought into or out of engagement with each other. Since the truck mixer gearbox 7 is substantially disposed in a fixed position on the motor vehicle, the coupling and uncoupling between the electric motor 6 and the truck mixer gearbox 7 is carried out, for example, by the electric motor 6 being displaced. This movement, and also the actuation of the remaining clutches (4a, 5a, 6a) can be effected in many ways, for example hydraulically or pneumatically, but electric, electromechanical or electromagnetic actuation is preferred. Here, because of their ruggedness in a rough environment, because of their low wear and the ability to be driven easily, electromagnets are particularly suitable. However, within the context of the invention, actuating motors or actuating cylinders operated by compressed air or hydraulically can also be used for the actuation of the clutches. In addition, manual actuation is covered by the idea of the invention.

The electric motor 6 according to the invention is preferably connected mechanically to the housing of the truck mixer gearbox 7, in exactly the same way as the hydraulic motor 5 and the associated second clutch 5a and the third clutch 6a—if such a one is present. This housing is advantageously constructed such that the hydraulic motor 5 and the electric motor 6 can be flange-mounted on said housing, which makes mounting and maintenance easier. The couplings 5a and 6a can if desired be formed integrally with the associated drive, hydraulic motor 5 or electric motor 6, or with the truck mixer gearbox 7.

The operating mode of the drive unit of the invention according to FIG. 1 is as follows: during loading, during mixing operation or during discharging of the finished mixture on the building site, the drive of the mixing drum 8 has a high power demand, which can be in the region of 100 kW. The motor vehicle which carries the mixing drum 8 is normally stationary here, so that substantially the entire power of the drive engine 1 is available. With the first clutch 4a engaged, this power is transmitted to the hydraulic displacement pump 4 and, in accordance with the control signals applied to the adjusting unit 4a, effects a volume flow of pressurized fluid in the hydraulic lines 13. This flow drives the hydraulic motor 5, which acts on the truck mixer gearbox 7 via the engaged coupling 5a and thus sets the mixing drum 8 rotating. The truck mixer gearbox reduces the rotational speed in such a way that the mixing drum 8 executes approximately 15 to 20 revolutions per minute. This relatively high rotational speed is required for the loading, mixing and discharging of the finished concrete.

Since the drive engine 1 of the motor vehicle usually a diesel engine—which, in this operating mode, runs under relatively high load in an optimized state—the drive engine 1 operates in a range that is beneficial with respect to fuel consumption and reduced pollutant development. At the same time, the charging of the accumulator of the power supply 2 of the electrical system is maintained or generated.

The electric motor 6 provided in accordance with the invention is preferably not in operation in high-load operation here, and the third clutch 6a shown in FIG. 1 is disengaged. If such a clutch is not present, as in the second exemplary embodiment described, although the rotor of the electric motor co-rotates if no freewheel is interposed, the electric motor acts here as a generator. It thus outputs no drive power to the mixing drum but, if appropriate, charges the accumulator of the power supply 2.

In driving operation, that is to say during the transport of concrete, only relatively slow rotation of the mixing drum 8 is required at only a few revolutions per minute, for which purpose a drive power of a few kW is adequate. According to the invention, this power is no longer branched off from the drive engine 2 of the motor vehicle, as hitherto in accordance with the prior art, but is supplied directly by the electric motor 6 according to the invention. For this purpose, the first and/or the second clutch (4a and 5a) are disengaged, which is done by appropriately driving the clutches 4a and 5a by the control electronics 3a of the control unit 3. The displacement pump 4 and the hydraulic motor 5 no longer experience any drive when the first clutch 4a is disengaged and no longer act on the mixing drum 8 either. Instead, the electric motor 6 is started and, in the exemplary embodiment according to FIG. 1, for example, the third clutch 6a is engaged. The torque produced by the electric motor 6 preferably acts on an input-side drive shaft 14a or 16a of the truck mixer gearbox 7 and, as a result, sets the mixing drum 8 rotating.

The power supply of the electric motor 6 is provided via the power stage 3b of the control unit 3 from the power supply 2 of the electrical system. This power supply 2 is assisted during driving operation of the motor vehicle by the generator driven by the drive engine 1, i.e. the conventional alternator, so that the latter can also provide the power required for the operation of the electric motor 6 for a relatively long time.

In the exemplary embodiment shown in FIG. 2, for example for the short-term disconnection of the hydraulic drive of the mixing drum 8, the hydraulic motor 5 which, in this case, preferably represents a fixed displacement motor, can be bypassed via a bypass line 13a. To this end, the bypass valve 13b disposed in the bypass line 13a is opened, as a result of which the hydraulic oil flow generated by the displacement pump 4 is led past the hydraulic motor 5. The hydraulic motor 5 thus transmits no torque via the drive train 14/14a to the mixing drum gearbox 7. This short-circuiting of the hydraulic motor 5 is equivalent to disengaging a clutch, since the drive train 14/14a is interrupted. Consequently, the second clutch 5a in the exemplary embodiment according to FIG. 2 can be omitted if it is accepted that the hydraulic motor 5 co-rotates idly when the mixing drum 8 is driven by the electric motor 6. However, as compared with the mass of the filled mixing drum 8, the mass of the hydraulic motor 5 additionally to be rotated in this case by the electric motor 6 can be estimated to be negligibly low.

In FIG. 2, a gearbox 18 is additionally connected between the electric motor 6 and the third clutch 6a and can usually be controlled by means customary in the art in such a way that it is able to keep the rotational drive speed of the electric motor 6 in the optimal range, at the same time the rotational speed of the mixing drum 8 being adjustable. Likewise, and with the same effect, the gearbox 18 can also be disposed on the drive shaft 16a of the mixing drum 8. Furthermore, as already indicated previously, a freewheel for the electric motor 6 can be provided in the gearbox 18, in order that co-rotation of the electric motor 6 is avoided if the mixing drum 8 is set rotating by the hydraulic drive and no third clutch 6a is provided in the electromechanical drive train for the mixing drum.

In a further exemplary embodiment, which is illustrated in FIG. 3, the electromechanical drive of the mixing drum 8 via the electric motor 6 is disposed in series, i.e. serially, with respect to the hydraulic drive of the mixing drum 8. In the operating behavior of the two drives, no difference results here from the parallel dispositions according to FIGS. 1 and 2, but a serial disposition can be constructed in a more space-saving manner. As FIG. 3 shows, the output shaft 16 of the electric motor 6 is led through the hydraulic motor 5 and can drive the mixing drum 8 on its own and directly. The drive shaft 16a of the mixing drum 8 is preferably provided with a freewheel as it passes through the hydraulic motor 5, so that when the mixing drum 8 is driven by the electric motor 6, the hydraulic motor 5 is not co-rotated. In this case, the system of the alternative drive possibilities for the mixing drum 8 of a truck mixer 1 manages with only a single clutch 4a for the mixing drum drive. If the hydraulic drive is shut down via the clutch 4a, the mixing drum 8 can be set and kept rotating by the electric motor 6 via the freewheel in the hydraulic motor 5.

In the exemplary embodiment illustrated in FIG. 3 as well, the hydraulic motor 5 can be short-circuited via a bypass line 13a if the bypass valve 13b disposed in the bypass line 13a is opened and thus the hydraulic fluid supply for the hydraulic motor 5 is interrupted. The bypass line 13a acts together with the bypass valve 13b in this case as a hydraulic clutch, so that the mechanical clutch 5a, as illustrated in FIGS. 1 and 2, for example, can be omitted. The connection and disconnection of the hydraulic drive can be controlled here via the bypass valve 13b; the electric motor 6 can, if appropriate, be taken out of the drive train 14/14a via a clutch 6a during the hydraulic drive of the mixing drum 8 or, for example, can also be driven by the hydraulic drive for power generation and energy recovery. In the simplest case, the clutch 6a for connecting and disconnecting the electric motor 6 in the drive of the mixing drum 8 can also be omitted, which means that the complete auxiliary drive of the truck mixer for rotating the mixing drum 8 manages with only one clutch 4a.

Following the model of FIGS. 1 and 2, the possibility is also provided for the embodiment which is illustrated in FIG. 3 of separating the electromechanical drive from the drive shaft 16a of the mixing drum 8 by means of a clutch 6a. A gearbox 18 disposed in the electromechanical drive for the mixing drum 8 is covered by the idea of the invention in exactly the same way as a gearbox 18 provided in the serial embodiments of FIGS. 1 and 2.

### LIST OF DESIGNATIONS

1 Drive engine

2 Power supply

3 Control unit

3a Control electronics

3b Power stage

4 Hydraulic displacement pump

4a First clutch

4b Adjusting unit

5 Hydraulic motor

5a Second clutch

6 Electric motor

6a Third clutch

7 Truck mixer gearbox

8 Mixing drum

9 Rotational speed sensor

10 Generator

11 Output shaft of the drive engine

11a Drive shaft of the displacement pump

12 Transmission

13 Hydraulic lines

13a Bypass line

13b Bypass valve

14 Output shaft of the hydraulic motor

14a Drive shaft of the truck mixer gearbox

15 Electric lines

16 Output shaft of the electric motor

16a Further drive shaft of the truck mixer gearbox

17 Accumulator

18 Gearbox

1. A drive unit for a mixing drum (8) that is disposed on a motor vehicle,
having a hydraulic drive, which comprises a hydraulic displacement pump (4) driven by the drive engine (1) of the motor vehicle and a hydraulic motor (5) fed by said pump, which is coupled via a truck mixer gearbox (7) to the mixing drum (8) in order to drive the latter in rotation,
having an electric energy store (2), which is connected to an electrical system (1) of the motor vehicle, and
having an electric motor (6), which can be activated by the energy store (2) as stipulated by the control unit (3),
that a first clutch (4a) is disposed between the drive engine (1) of the motor vehicle and the displacement pump (4),
characterized
in that a second clutch (5a) is disposed between the hydraulic motor (5) and the truck mixer gearbox (7), and
in that the electric motor (6) can be connected to the truck mixer gearbox (7) in such a way that the mixing drum (8) can be driven solely and directly by the electric motor (6).

2. The drive unit for a mixing drum (8) that is disposed on a motor vehicle as claimed in claim 1, characterized in that a third clutch (6a) is disposed between the electric motor (6) and the truck mixer gearbox (7).

3. The drive unit for a mixing drum (8) that is disposed on a motor vehicle as claimed in claim 1, characterized in that in the first, second and—if present—the third clutch (4a, 5a, 6a) and the electric motor (6) and the displacement pump (5) are connected to the control unit (6) and can be actuated via the latter.

4. The drive unit for a mixing drum (8) that is disposed on a motor vehicle as claimed in claim 1, characterized in that the control unit (3) has control-electronics (3a) and a power stage (3b) for the drive and the power supply of the electric motor (6).

5. The drive unit for a mixing drum (8) that is disposed on a motor vehicle as claimed in claim 1, characterized in that the clutches (4a, 5a, 6a) can be actuated electrically or electromagnetically.

6. The drive unit for a mixing drum (8) that is disposed on a motor vehicle as claimed in claim 1, that there is a rotational speed sensor (9) for measuring the rotational speed of the mixing drum (8), which sensor is connected to the control electronics (3a).

7. The drive unit for a mixing drum (8) that is disposed on a motor vehicle as claimed in claim 6, characterized in that the rotational speed sensor (9) is disposed on the truck mixer gearbox (7).

8. The drive unit for a mixing drum (8) that is disposed on a motor vehicle as claimed in claim 1, characterized in that the power supply of the motor vehicle comprises the electric energy store (2) or forms the latter.

9. The drive unit for a mixing drum (8) that is disposed on a motor vehicle as claimed in claim 1, characterized in that the electric motor (6) and the hydraulic motor (5) for driving the mixing drum (8) are disposed serially on a drive train (14, 14a).

10. The drive unit for a mixing drum (8) that is disposed on a motor vehicle as claimed in claim 1, characterized in that the hydraulic motor (5) can be bypassed by means of a bypass line (13a), in which a bypass valve (13b) is disposed, in such a way that the hydraulic motor (5) and the bypass line (13a) together form the second clutch (5a).
